(19) United States
(12) Patent Application Publication
(10) Pub. No.: US 2024/0317322 A1
(43) Pub. Date: Sep. 26, 2024

(54) VEHICLE BODY LOWER STRUCTURE

(71) Applicant: Honda Motor Co., Ltd., Tokyo (JP)

(72) Inventors: Nozomi MIKAMI, Tokyo (JP); Shungo CHINO, Tokyo (JP); Taiki TERUI, Tokyo (JP)

(73) Assignee: Honda Motor Co., Ltd., Tokyo (JP)

(21) Appl. No.: 18/586,514

(22) Filed: Feb. 25, 2024

(30) Foreign Application Priority Data
Mar. 23, 2023 (CN) 202310291253.8

(51) Int. Cl. B62D 25/20; B62D 25/02

(52) U.S. Cl. CPC B62D 25/2036; B62D 25/025

(57) ABSTRACT

The disclosure provides a vehicle body lower structure disposed in a vehicle and including a floor panel; a side beam disposed on an outer side of the floor panel in a width direction of the vehicle and extending in a front-rear direction of the vehicle; and a rear side frame connected to a rear side of the side beam and an inner side of the side beam in the width direction of the vehicle and extending in the front-rear direction of the vehicle. An inner wall of the side beam has an inclined surface inclined toward a rear of the vehicle and an outer side in the width direction of the vehicle. A front end edge of the rear side frame is joined to the inclined surface.

### CROSS-REFERENCE TO RELATED APPLICATION

This application claims the priority benefits of China application no. 202310291253.8, filed on Mar. 23, 2023. The entirety of the above-mentioned patent application is hereby incorporated by reference herein and made a part of this specification.

### BACKGROUND

### Technical Field

The disclosure relates to a vehicle body lower structure.

### Description of Related Art

In recent years, efforts have been made to provide sustainable transportation systems that take into account vulnerable groups among transportation participants, such as the elderly, persons with disabilities, and children. For this purpose, the technologies are being developed to enhance vehicle body rigidity to further improve traffic safety and convenience.

In Patent Document 1 (Japanese Patent Application Laid-Open No. 7-323866), the side sill inner of the side beam and the side sill inner frame of the side beam are connected to the rear side frame so as to face each other in the width direction of the vehicle, thereby ensuring the joint strength between the side beam and the rear side frame.

However, according to Patent Document 1, when the side beam is composed of the side sill inner of the side beam and the side sill inner frame of the side beam, the overall structure is complicated, and the number and weight of parts increase. In addition, since the side beam and the rear side frame are connected in the width direction of the vehicle, the joint portion of the side beam and the rear side frame is located in the shearing direction with respect to the input in the front-rear direction of the vehicle. Thus, there is a possibility that breakage or peeling may occur.

The disclosure provides a vehicle body lower structure that ensures the joint strength and rigidity between the side beam and the rear side frame with a simple structure. By providing an inclined surface on the rear side of the side beam and joining the rear side frame to the inclined surface, the front end edge of the rear side frame can be enlarged without interfering with the interior space of the vehicle, and a load in the front-rear direction of the vehicle can be transferred to the side beam through the inclined surface, thereby ensuring rigidity without reinforcing the joint portion between the rear side frame and the side beam.

### SUMMARY

An embodiment of the disclosure provides a vehicle body lower structure. The vehicle body lower structure is configured to be disposed in a vehicle. The vehicle body lower structure includes: a floor panel; a side beam disposed on an outer side of the floor panel in a width direction of the vehicle and extending in a front-rear direction of the vehicle; and a rear side frame connected to a rear side of the side beam and an inner side of the side beam in the width direction of the vehicle and extending in the front-rear direction of the vehicle. An inner wall of the side beam has an inclined surface that is inclined toward a rear of the vehicle and an outer side in the width direction of the vehicle. A front end edge of the rear side frame is joined to the inclined surface.

### BRIEF DESCRIPTION OF THE DRAWINGS

FIG. 1 is a schematic view of a vehicle body lower structure disposed in a vehicle according to an embodiment of the disclosure.

FIG. 2 is a schematic plan view of the vehicle body lower structure in FIG. 1.

FIG. 3 is a partially enlarged schematic view of the vehicle body lower structure in FIG. 1.

FIG. 4 is a schematic view of the lower member and the upper member of the rear side frame, and the joint structure between the rear side frame and the side beam in the vehicle body lower structure according to an embodiment of the disclosure.

FIG. 5 is a schematic view of the opening provided at the front end of the closed cross section of the rear side frame, and the joint structure between the rear side frame and the side beam in the vehicle body lower structure according to an embodiment of the disclosure.

FIG. 6 is a schematic view showing the relationship between the length of the front end edge of the rear side frame and the length of the rear side frame in the vertical direction in the vehicle body lower structure according to an embodiment of the disclosure.

FIG. 7 is a schematic view of a vehicle body lower structure disposed in a vehicle according to another embodiment of the disclosure.

FIG. 8 is a schematic view of a vehicle body lower structure according to yet another embodiment of the disclosure.

FIG. 9 is a partially enlarged schematic view of the vehicle body lower structure in FIG. 8.

FIG. 10 is a schematic view of a vehicle body lower structure according to yet another embodiment of the disclosure.

FIG. 11 is a schematic view of a vehicle body lower structure according to yet another embodiment of the disclosure.

### DESCRIPTION OF THE EMBODIMENTS

An embodiment of the disclosure provides a vehicle body lower structure. The vehicle body lower structure is configured to be disposed in a vehicle. The vehicle body lower structure includes: a floor panel; a side beam disposed on an outer side of the floor panel in a width direction of the vehicle and extending in a front-rear direction of the vehicle; and a rear side frame connected to a rear side of the side beam and an inner side of the side beam in the width direction of the vehicle and extending in the front-rear direction of the vehicle. An inner wall of the side beam has an inclined surface that is inclined toward a rear of the vehicle and an outer side in the width direction of the vehicle. A front end edge of the rear side frame is joined to the inclined surface.

The front end edge of the rear side frame and the inclined surface of the side beam are joined so as to face each other, thereby improving the load transfer efficiency between the rear side frame and the side beam and ensuring sufficient connection strength.

In an embodiment of the disclosure, the rear side frame includes a closed cross section composed of a lower member and an upper member. A front end of the closed cross section is provided with an opening. The opening is joined to the inclined surface.

By joining the closed cross section of the rear side frame and the inclined surface of the side beam in this way, the load transfer efficiency between the rear side frame and the side beam is improved, thereby ensuring sufficient connection strength.

In an embodiment of the disclosure, a length of the front end edge of the rear side frame is greater than a length in a direction perpendicular to a length direction of the rear side frame.

By lengthening the front end edge of the rear side frame that is joined to the inclined surface of the side beam, the surrounding space is secured and the joint strength is ensured.

In an embodiment of the disclosure, the vehicle body lower structure further includes an end plate disposed at a rear end of the side beam. The end plate is joined to a rear flange of the side beam and a side wall of the lower member.

As the end plate disposed at the rear end of the side beam is joined to the rear flange of the side beam and the side wall of the rear side frame, when a load is input in the front-rear direction of the vehicle, the efficiency of transferring the load between the rear side frame and the side beam is improved, thereby improving the joint strength. Specifically, the rear side frame, the end plate, and the side beam are joined in the front-rear direction of the vehicle so as not to separate from each other. Therefore, the load can be transferred from the rear side frame to the end plate, causing the end plate to push the rear surface of the side beam to transfer the load. In addition, the end plate is joined to the side wall to provide sufficient rigidity so as to resist a load in the width direction of the vehicle.

In an embodiment of the disclosure, the front end edge of the rear side frame includes a first joining flange joined to the inclined surface; and a second joining flange sandwiched between the end plate and the rear flange to be joined.

As the front end edge (first joining flange) of the rear side frame is joined to the inclined surface of the side beam and the second joining flange is sandwiched between the end plate and the rear flange of the side beam and joined in the front-rear direction of the vehicle, when a load is input in the front-rear direction of the vehicle, the efficiency of transferring the load between the rear side frame and the side beam is improved, thereby improving the joint strength. Specifically, the inclined surface of the side beam and the rear flange are joined to each other in the front-rear direction of the vehicle so as not to separate from each other. Therefore, a load from the rear side frame can be effectively transferred through the inclined surface of the side beam and the rear flange.

In an embodiment of the disclosure, the rear side frame is connected to an upper side of the side beam. The end plate includes an outer joint portion connected to the side beam below the rear side frame. The outer joint portion is respectively connected to an outer surface of the inner wall of the side beam in the width direction of the vehicle and a lower surface of a lower wall of the side beam.

By joining the lower side of the end plate to the outer surface of the side beam (that is, the lower surface of the lower wall and the outer surface of the inner wall) in this way, a load input to the end plate can be effectively transferred to the side beam or the rear side frame, thereby improving the joint strength.

In an embodiment of the disclosure, the floor panel includes a floor cross beam extending in the width direction of the vehicle on an upper surface of the floor panel and spaced apart from the rear side frame in the front-rear direction of the vehicle. The side beam includes an extension member extending in the front-rear direction of the vehicle on an outer side of the inner wall in the width direction of the vehicle. The rear side frame and the floor cross beam are respectively connected to the extension member.

As the rigidity of the rear side frame and the side beam is ensured to resist a load in the front-rear direction of the vehicle, the floor cross beam can be positioned away from the rear side frame, allowing the rear side frame to be used in other types of vehicles (no special design is required for the rear side frame). In addition, since the load between the rear side frame and the floor cross beam can be transferred through the extension member of the side beam, higher rigidity is ensured.

The vehicle body lower structure according to the disclosure has at least the following technical effects.

The front end edge of the rear side frame and the inclined surface of the side beam are joined so as to face each other, thereby improving the load transfer efficiency between the rear side frame and the side beam and ensuring sufficient connection strength.

By joining the closed cross section of the rear side frame and the inclined surface of the side beam, the load transfer efficiency between the rear side frame and the side beam is improved, thereby ensuring sufficient connection strength.

By lengthening the front end edge of the rear side frame that is joined to the inclined surface of the side beam, the surrounding space is secured and the joint strength is ensured.

As the end plate disposed at the rear end of the side beam is joined to the rear flange of the side beam and the side wall of the rear side frame, when a load is input in the front-rear direction of the vehicle, the efficiency of transferring the load between the rear side frame and the side beam is improved, thereby improving the joint strength. Specifically, the rear side frame, the end plate, and the side beam are joined in the front-rear direction of the vehicle so as not to separate from each other. Therefore, the load can be transferred from the rear side frame to the end plate, causing the end plate to push the rear surface of the side beam to transfer the load. In addition, the end plate is joined to the side wall to provide sufficient rigidity so as to resist a load in the width direction of the vehicle.

As the front end edge (first joining flange) of the rear side frame is joined to the inclined surface of the side beam and the second joining flange is sandwiched between the end plate and the rear flange of the side beam and joined in the front-rear direction of the vehicle, when a load is input in the front-rear direction of the vehicle, the efficiency of transferring the load between the rear side frame and the side beam is improved, thereby improving the joint strength. Specifically, the inclined surface of the side beam and the rear flange are joined to each other in the front-rear direction of the vehicle so as not to separate from each other. Therefore, a load from the rear side frame can be effectively transferred through the inclined surface of the side beam and the rear flange.

By joining the lower side of the end plate to the outer surface of the side beam (that is, the lower surface of the lower wall and the outer surface of the inner wall), a load input to the end plate can be effectively transferred to the side beam or the rear side frame, thereby improving the joint strength.

As the rigidity of the rear side frame and the side beam is ensured to resist a load in the front-rear direction of the vehicle, the floor cross beam can be positioned away from the rear side frame, allowing the rear side frame to be used in other types of vehicles (no special design is required for the rear side frame). In addition, since the load between the rear side frame and the floor cross beam can be transferred through the extension member of the side beam, higher rigidity is ensured.

In order to make the above-mentioned and other features and advantages of the disclosure more understandable, the following embodiments will be described in detail with reference to the accompanying drawings.

Hereinafter, embodiments of the disclosure will be described based on the drawings. It should be noted that in each of the embodiments described below, the same reference numerals are assigned to the same parts, and repeated description will be omitted. Hereinafter, embodiments of the disclosure will be described with reference to the drawings.

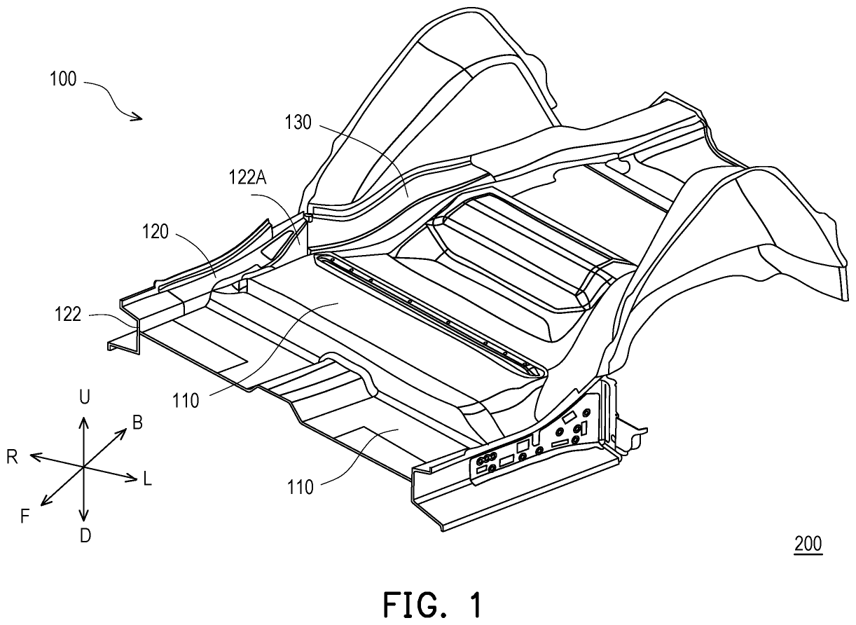

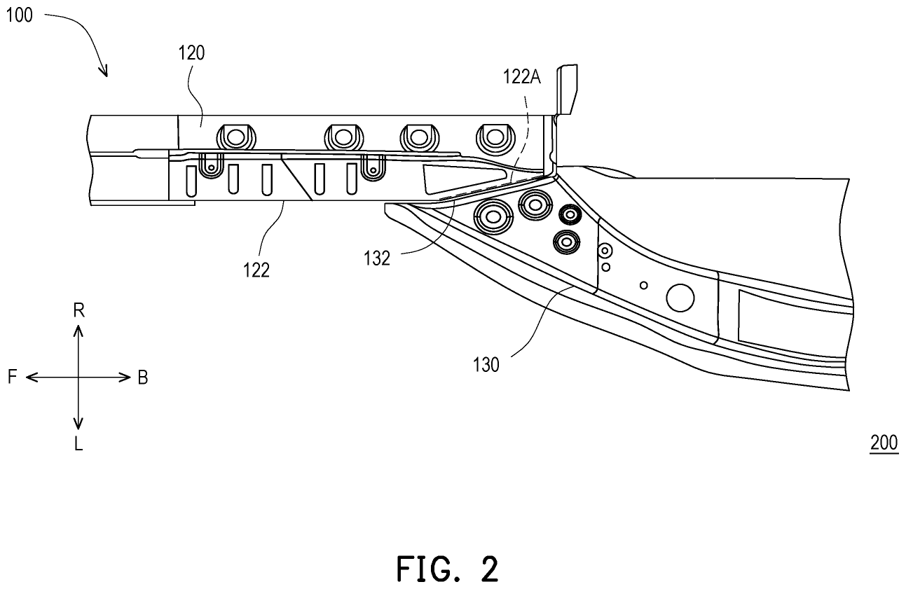

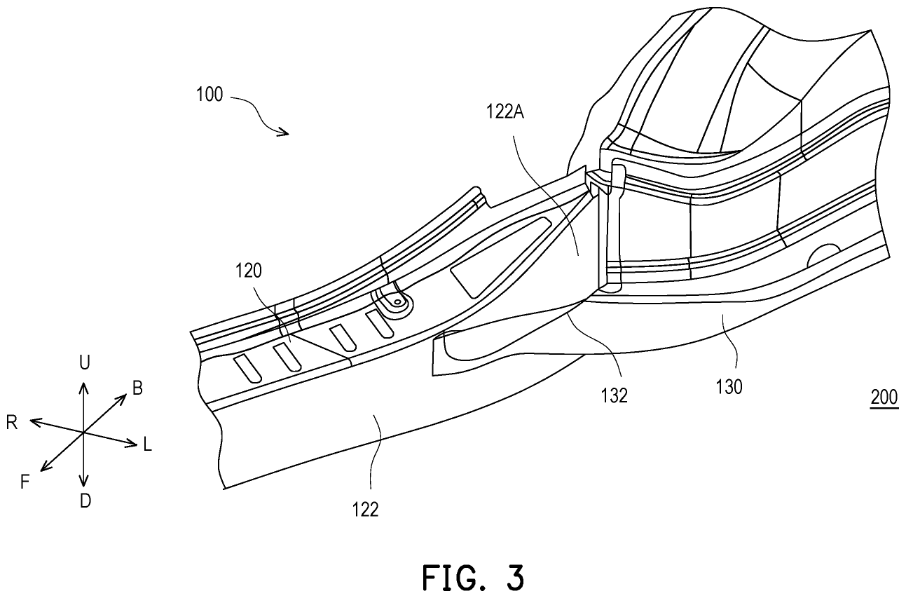

FIG. 1 is a schematic view of a vehicle body lower structure disposed in a vehicle according to an embodiment of the disclosure. FIG. 2 is a schematic plan view of the vehicle body lower structure in FIG. 1. FIG. 3 is a partially enlarged schematic view of the vehicle body lower structure in FIG. 1. FIG. 1 to FIG. 3 show a coordinate system of the front F, the rear B, the left L, the right R, the upper U, and the lower D of a vehicle 200.

Referring to FIG. 1 to FIG. 3, a vehicle body lower structure 100 is disposed in the vehicle 200. The vehicle body lower structure 100 includes a floor panel 110; a side beam 120 disposed on the outer side the floor panel 110 in the width direction L-R of the vehicle 200 and extending in the front-rear direction F-B of the vehicle 200; and a rear side frame 130 connected to the rear side of the side beam 120 and the inner side of the side beam 120 in the width direction L-R of the vehicle 200 and extending in the front-rear direction F-B of the vehicle 200. As shown in FIG. 2 and FIG. 3, an inner wall 122 of the side beam 120 has an inclined surface 122A that is inclined toward the rear B of the vehicle 200 and the outer side of the vehicle 200 in the width direction L-R. A front end edge 132 of the rear side frame 130 is joined to the inclined surface 122A.

In this way, the front end edge 132 of the rear side frame 130 and the inclined surface 122A of the side beam 120 are joined so as to face each other, thereby improving the load transfer efficiency between the rear side frame 130 and the side beam 120 and ensuring sufficient connection strength.

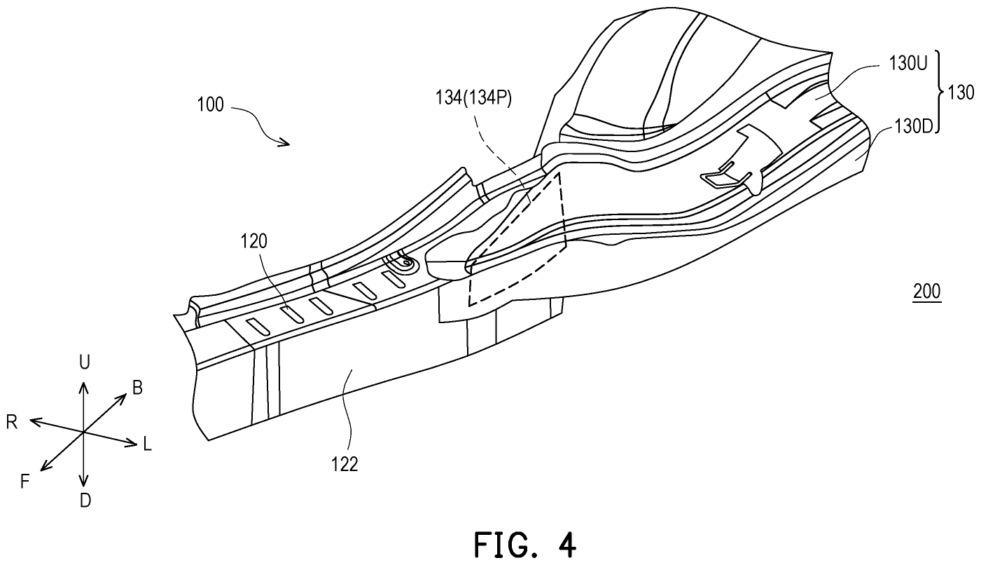

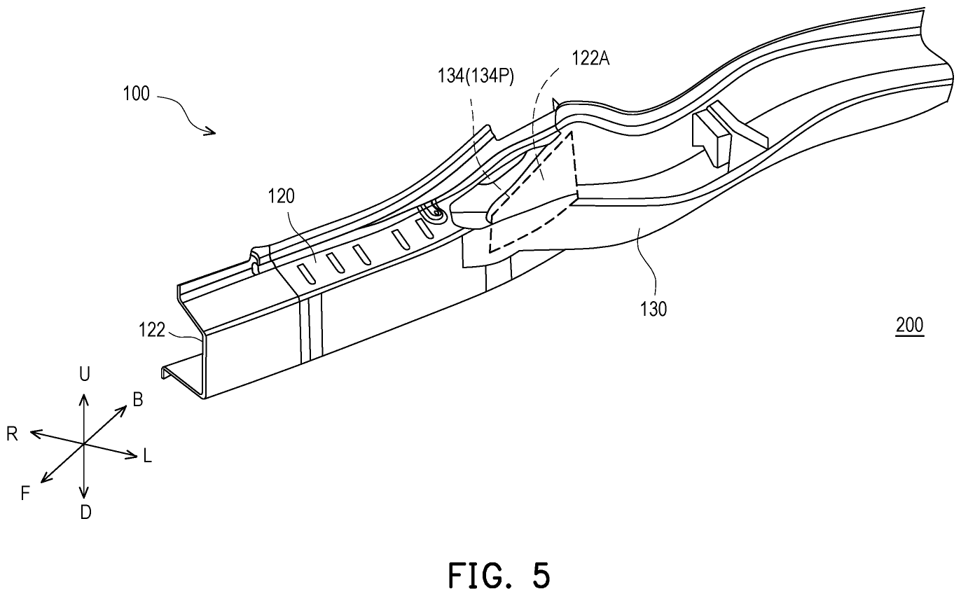

FIG. 4 is a schematic view of a lower member and an upper member of the rear side frame, and a joint structure between the rear side frame and the side beam in the vehicle body lower structure according to an embodiment of the disclosure. FIG. 5 is a schematic view of an opening provided at the front end of a closed cross section of the rear side frame, and the joint structure between the rear side frame and the side beam in the vehicle body lower structure according to an embodiment of the disclosure.

Referring to FIG. 4 and FIG. 5, the rear side frame 130 has a closed cross section 134 composed of a lower member 130D and an upper member 130U. An opening 134P is provided at the front end of the closed cross section 134. As shown in FIG. 5, the opening 134P is joined to the inclined surface 122A.

By joining the closed cross section 134 of the rear side frame 130 and the inclined surface 122A of the side beam 120 in this way, the load transfer efficiency between the rear side frame 130 and the side beam 120 is improved, thereby ensuring sufficient connection strength.

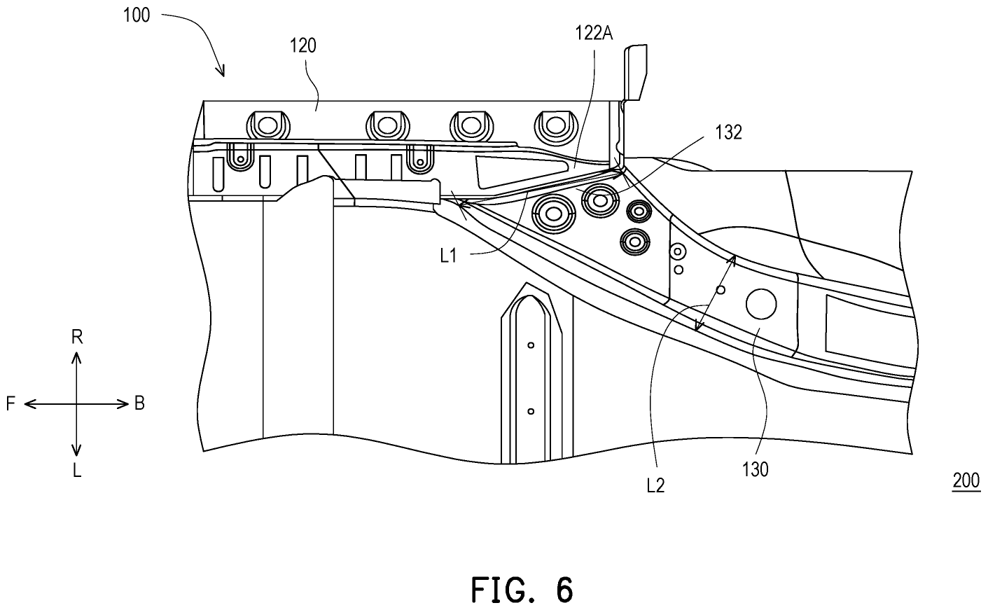

FIG. 6 is a schematic view showing the relationship between the length of the front end edge of the rear side frame and the length of the rear side frame in the vertical direction in the vehicle body lower structure according to an embodiment of the disclosure. Referring to FIG. 6, the length L1 of the front end edge 132 of the rear side frame 130 is greater than the length L2 in the direction perpendicular to the length direction of the rear side frame 130.

By lengthening the front end edge 132 of the rear side frame 130 that is joined to the inclined surface 122A of the side beam 120 in this way, the surrounding space is secured and the joint strength is ensured.

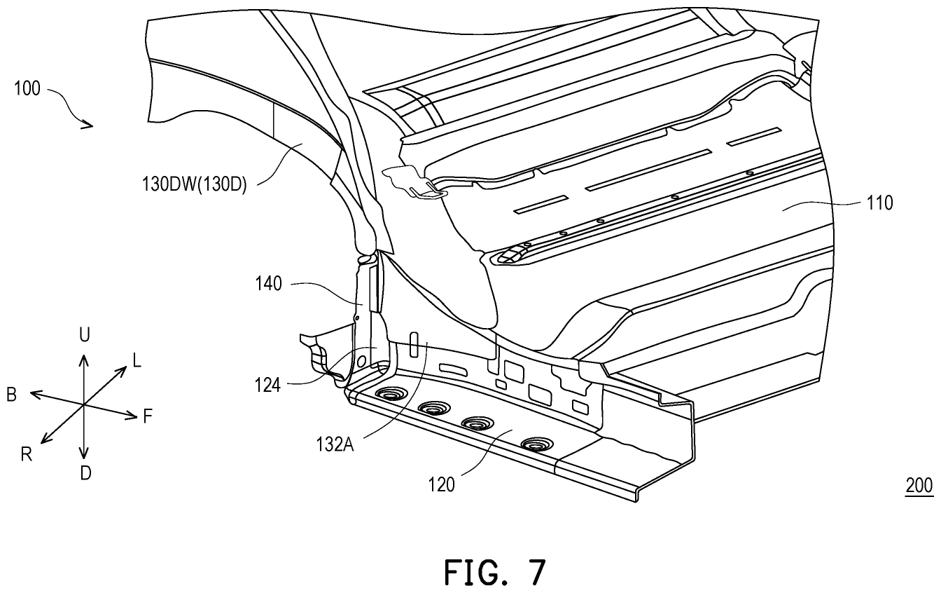

FIG. 7 is a schematic view of a vehicle body lower structure disposed in a vehicle according to another embodiment of the disclosure. Referring to FIG. 7, the vehicle body lower structure 100 further includes an end plate 140 disposed at a rear end B of the side beam 120. The end plate 140 is joined to a rear flange 124 of the side beam 120 and a side wall 130DW of the lower member 130D.

As the end plate 140 disposed at the rear end of the side beam 120 is joined to the rear flange 124 of the side beam 120 and the side wall 130DW of the rear side frame 130 in this way, when a load is input in the front-rear direction F-B of the vehicle 200, the efficiency of transferring the load between the rear side frame 130 and the side beam 120 is improved, thereby improving the joint strength. Specifically, the rear side frame 130, the end plate 140, and the side beam 120 are joined in the front-rear direction F-B of the vehicle 200 so as not to separate from each other. Therefore, the load can be transferred from the rear side frame 130 to the end plate 140, causing the end plate 140 to push the rear surface of the side beam 120 to transfer the load. In addition, the end plate 140 is joined to the side wall 130DW to provide sufficient rigidity so as to resist a load in the width direction L-R of the vehicle 200.

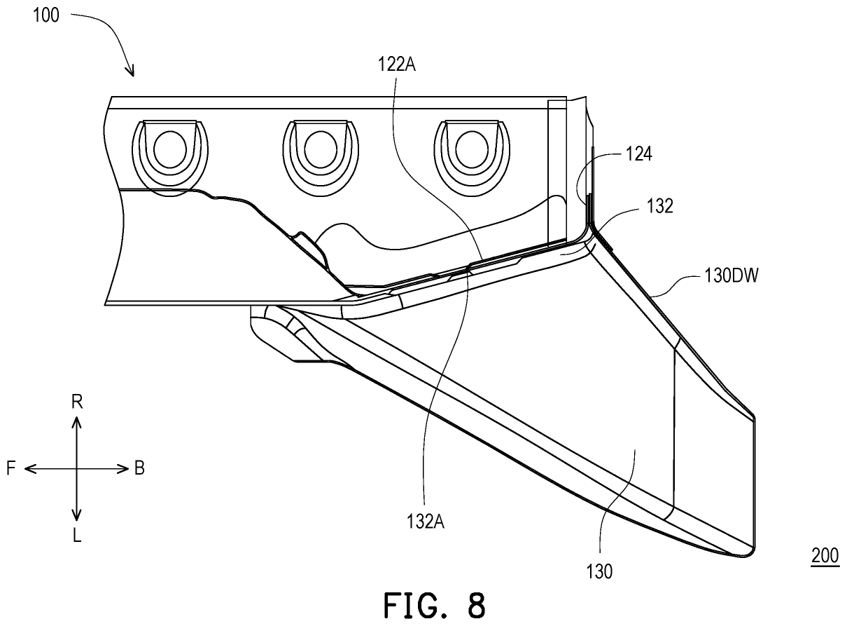

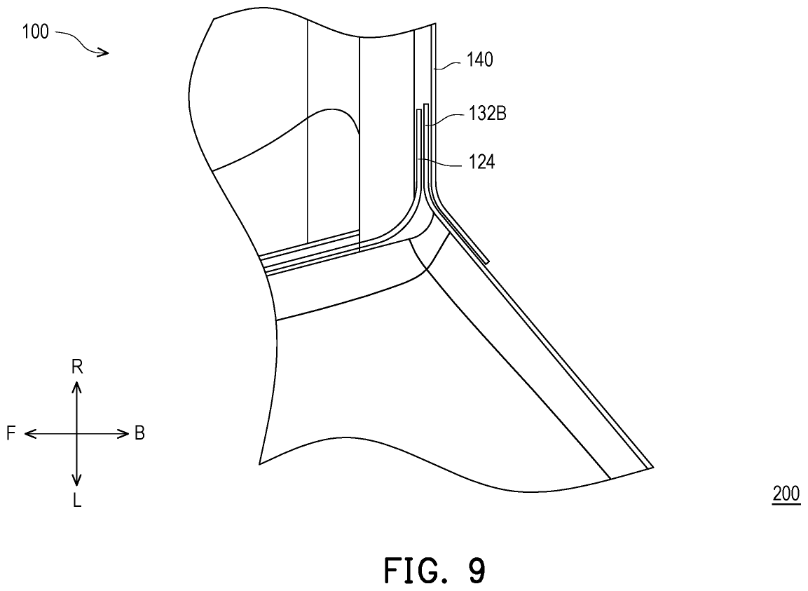

FIG. 8 is a schematic view of a vehicle body lower structure according to yet another embodiment of the disclosure. FIG. 9 is a partially enlarged schematic view of the vehicle body lower structure in FIG. 8.

Referring to FIG. 8 and FIG. 9, the front end edge 132 of the rear side frame 130 includes a first joining flange 132A joined to the inclined surface 122A, and a second joining flange 132B sandwiched between the end plate 140 and the rear flange 124 to be joined.

As the front end edge 132 (first joining flange 132A) of the rear side frame 130 is joined to the inclined surface 122A of the side beam 120 and the second joining flange 132B is sandwiched between the end plate 140 and the rear flange 124 of the side beam 120 and joined in the front-rear direction F-B of the vehicle 200 in this way, when a load is input in the front-rear direction F-B of the vehicle 200, the efficiency of transferring the load between the rear side frame 130 and the side beam 120 is improved, thereby improving the joint strength. Specifically, the inclined surface 122A of the side beam 120 and the rear flange 124 are joined to each other in the front-rear direction F-B of the vehicle 200 so as not to separate from each other. Therefore, a load from the rear side frame 130 can be effectively transferred through the inclined surface 122A of the side beam 120 and the rear flange 124.

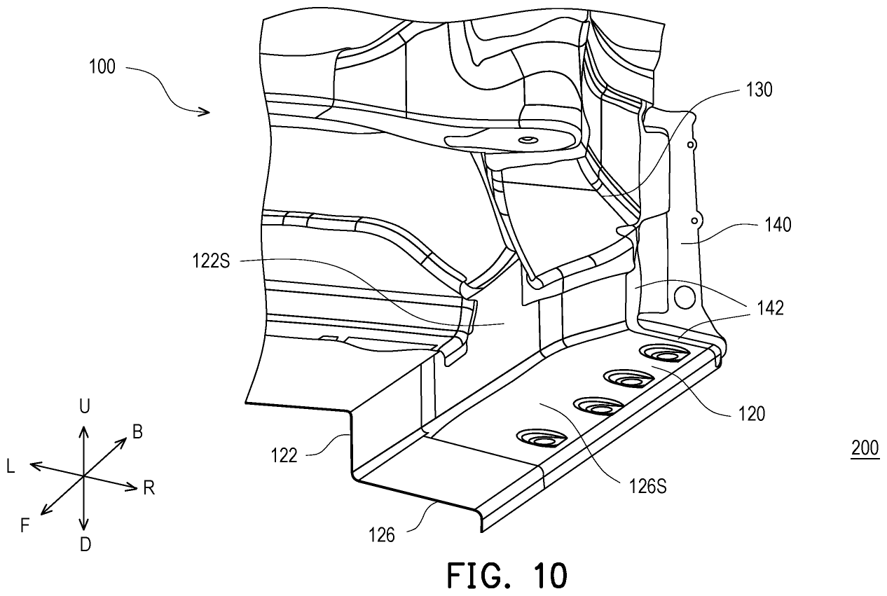

FIG. 10 is a schematic view of a vehicle body lower structure according to yet another embodiment of the disclosure.

Referring to FIG. 10, the rear side frame 130 is connected to the upper side of the side beam 120. The end plate 140 has an outer joint portion 142 connected to the side beam 120 below the rear side frame 130. The outer joint portion 142 is respectively connected to an outer surface 122S of the inner wall 122 of the side beam 120 in the width direction L-R of the vehicle 200 and a lower surface 126S of a lower wall 126 of the side beam 120.

By joining the lower side of the end plate 140 to the outer surface of the side beam 120 (that is, the lower surface 126S of the lower wall 126 and the outer surface 122S of the inner wall 122) in this way, a load input to the end plate 140 can be effectively transferred to the side beam 120 or the rear side frame 130, thereby improving the joint strength.

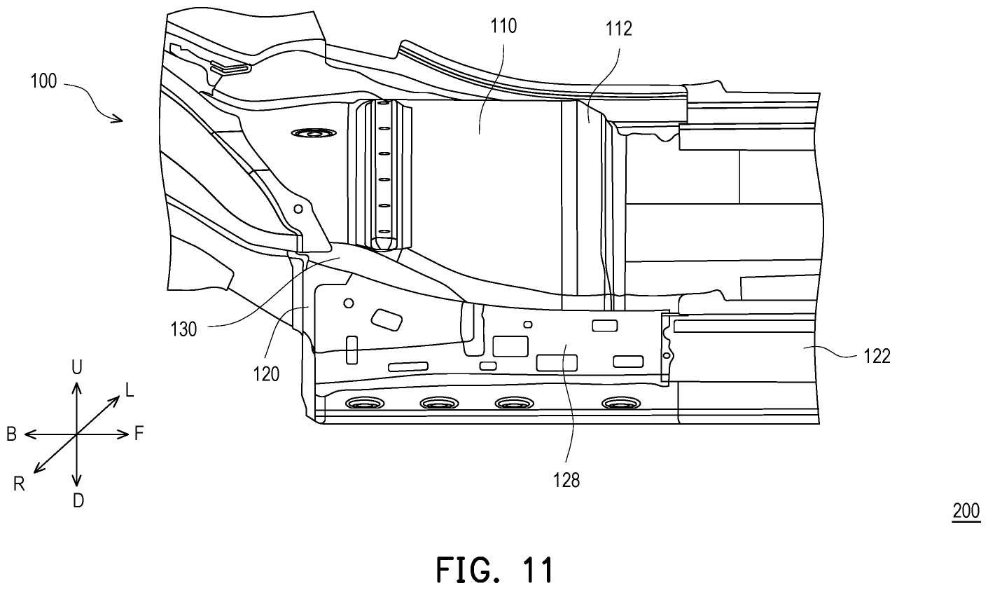

FIG. 11 is a schematic view of a vehicle body lower structure according to yet another embodiment of the disclosure. Referring to FIG. 11, the floor panel 110 includes a floor cross beam 112 extending in the width direction L-R of the vehicle 200 on the upper surface of the floor panel 110 and spaced apart from the rear side frame 130 in the front-rear direction F-B of the vehicle 200. The side beam 120 includes an extension member 128 extending in the front-rear direction F-B of the vehicle 200 on the outer side of the inner wall 122 in the width direction L-R of the vehicle 200. The rear side frame 130 and the floor cross beam 112 are respectively connected to the extension member 128.

As the rigidity of the rear side frame 130 and the side beam 120 is ensured in this way to resist a load in the front-rear direction F-B of the vehicle 200, the floor cross beam 112 can be positioned away from the rear side frame 130, allowing the rear side frame 130 to be used in other types of vehicles (no special design is required for the rear side frame 130). In addition, since the load between the rear side frame 130 and the floor cross beam 112 can be transferred through the extension member 128 of the side beam 120, higher rigidity is ensured.

Based on the above, the vehicle body lower structure of the disclosure has at least the following technical effects.

The front end edge of the rear side frame and the inclined surface of the side beam are joined so as to face each other, thereby improving the load transfer efficiency between the rear side frame and the side beam and ensuring sufficient connection strength.

By joining the closed cross section of the rear side frame and the inclined surface of the side beam, the load transfer efficiency between the rear side frame and the side beam is improved, thereby ensuring sufficient connection strength.

By lengthening the front end edge of the rear side frame that is joined to the inclined surface of the side beam, the surrounding space is secured and the joint strength is ensured.

As the end plate disposed at the rear end of the side beam is joined to the rear flange of the side beam and the side wall of the rear side frame, when a load is input in the front-rear direction of the vehicle, the efficiency of transferring the load between the rear side frame and the side beam is improved, thereby improving the joint strength. Specifically, the rear side frame, the end plate, and the side beam are joined in the front-rear direction of the vehicle so as not to separate from each other. Therefore, the load can be transferred from the rear side frame to the end plate, causing the end plate to push the rear surface of the side beam to transfer the load. In addition, the end plate is joined to the side wall to provide sufficient rigidity so as to resist a load in the width direction of the vehicle.

As the front end edge (first joining flange) of the rear side frame is joined to the inclined surface of the side beam and the second joining flange is sandwiched between the end plate and the rear flange of the side beam and joined in the front-rear direction of the vehicle, when a load is input in the front-rear direction of the vehicle, the efficiency of transferring the load between the rear side frame and the side beam is improved, thereby improving the joint strength.

Specifically, the inclined surface of the side beam and the rear flange are joined to each other in the front-rear direction of the vehicle so as not to separate from each other. Therefore, a load from the rear side frame can be effectively transferred through the inclined surface of the side beam and the rear flange.

By joining the lower side of the end plate to the outer surface of the side beam (that is, the lower surface of the lower wall and the outer surface of the inner wall), a load input to the end plate can be effectively transferred to the side beam or the rear side frame, thereby improving the joint strength.

As the rigidity of the rear side frame and the side beam is ensured to resist a load in the front-rear direction of the vehicle, the floor cross beam can be positioned away from the rear side frame, allowing the rear side frame to be used in other types of vehicles (no special design is required for the rear side frame). In addition, since the load between the rear side frame and the floor cross beam can be transferred through the extension member of the side beam, higher rigidity is ensured.

Finally, it should be noted that the above embodiments are illustrative, rather than restrictive, to the technical solutions of the disclosure. Although the disclosure has been described in detail with reference to the above embodiments, those skilled in the art should understand that it is possible to modify the technical solutions described in the above embodiments or to equivalently substitute some or all of the technical features. These modifications or substitutions do not cause the essence of the corresponding technical solutions to depart from the scope of the technical solutions of the embodiments of the disclosure.

What is claimed is:

1. A vehicle body lower structure, configured to be disposed in a vehicle, the vehicle body lower structure comprising:
a floor panel;
a side beam disposed on an outer side of the floor panel in a width direction of the vehicle and extending in a front-rear direction of the vehicle; and
a rear side frame connected to a rear side of the side beam and an inner side of the side beam in the width direction of the vehicle and extending in the front-rear direction of the vehicle,
wherein an inner wall of the side beam has an inclined surface that is inclined toward a rear of the vehicle and an outer side in the width direction of the vehicle, and
a front end edge of the rear side frame is joined to the inclined surface.

2. The vehicle body lower structure according to claim 1, wherein the rear side frame comprises a closed cross section composed of a lower member and an upper member,
a front end of the closed cross section is provided with an opening, and
the opening is joined to the inclined surface.

3. The vehicle body lower structure according to claim 1, wherein a length of the front end edge of the rear side frame is greater than a length in a direction perpendicular to a length direction of the rear side frame.

4. The vehicle body lower structure according to claim 2, further comprising:
an end plate disposed at a rear end of the side beam, and
the end plate is joined to a rear flange of the side beam and a side wall of the lower member.

5. The vehicle body lower structure according to claim 4, wherein the front end edge of the rear side frame comprises:
a first joining flange joined to the inclined surface; and
a second joining flange sandwiched between the end plate and the rear flange to be joined.

6. The vehicle body lower structure according to claim 5, wherein the rear side frame is connected to an upper side of the side beam,
the end plate comprises an outer joint portion connected to the side beam below the rear side frame, and
the outer joint portion is respectively connected to an outer surface of the inner wall of the side beam in the width direction of the vehicle and a lower surface of a lower wall of the side beam.

7. The vehicle body lower structure according to claim 1, wherein the floor panel comprises a floor cross beam extending in the width direction of the vehicle on an upper surface of the floor panel and spaced apart from the rear side frame in the front-rear direction of the vehicle,
the side beam comprises an extension member extending in the front-rear direction of the vehicle on an outer side of the inner wall in the width direction of the vehicle, and
the rear side frame and the floor cross beam are respectively connected to the extension member.
